(19) United States
(12) Patent Application Publication
(10) Pub. No.: US 2023/0119701 A1
(43) Pub. Date: Apr. 20, 2023

(54) PROCESS FOR CHEMICALLY MODIFYING A POLYMERIC PART IN ORDER TO IMPART ANTISTATIC PROPERTIES THERETO OR TO IMPROVE THESE PROPERTIES

(71) Applicant: COMMISSARIAT À L'ÉNERGIE ATOMIQUE ET AUX ÉNERGIES AL TERNATIVES, Paris (FR)

(72) Inventors: Jérôme Delmas, Grenoble (FR); Olivier Blanchot, Grenoble (FR); Pierre Piluso, Grenoble (FR); Olivier Poncelet, Grenoble (FR); Isabelle Rougeaux, Grenoble (FR)

(21) Appl. No.: 17/904,830

(22) PCT Filed: Feb. 17, 2021
(86) PCT No.: PCT/FR2021/050274

§ 371 Date: Aug. 23, 2022

(30) Foreign Application Priority Data
Feb. 26, 2020 (FR) FR2001883

(51) Int. Cl. C08J 7/02

(52) U.S. Cl. CPC C08J 7/02; C08J 2333/24

(57) ABSTRACT

A process for chemically modifying a polymeric part in order to impart antistatic properties thereto or to improve these properties, comprising the following steps: a step of reacting a polymeric part comprising at least one polymer comprising, as reactive groups, amine groups and/or hydroxyl groups, with a functional compound, also called first compound, comprising at least one isocyanate group and at least one heterocyclic type polymerisable group, the isocyanate groups covalently reacting with all or part of the amine groups and/or hydroxyl groups of the polymer(s), whereby this results in a polymeric part that is covalently bonded to residues of the functional compound; from the heterocyclic type polymerisable groups of the residues of the functional compound, a step of polymerising a second compound comprising at least one heterocyclic type polymerisable group in the presence of a metal complex, the reaction step and the polymerisation step being carried out in the presence of at least one supercritical fluid.

### TECHNICAL FIELD

The present invention relates to a process for chemically modifying a polymeric part in order to impart antistatic properties thereto or to improve these properties, this process being carried out in a medium allowing chemical modification both on the surface and in the core of the polymeric part, in other words in the whole volume of the part.

Conventionally, properties of a polymeric part can be modified or improved in various ways, such as, for example:
the addition of one or more organic or inorganic fillers to form a composite material, however with the possibility of the presence of fillers having a negative effect on the properties of the polymer which it is not desired to modify; or
the impregnation of the polymer with one or more chemical agents to impart or improve the targeted property, but with the following drawback(s):
the impregnation only results in a surface treatment and does not allow the part to be reached in depth, the targeted property thus being only situated on the surface of the part;
the impregnation does not allow strong binding of the chemical agent(s), the targeted property imparted by this/these agent(s) not having a satisfactory resistance in time.

In view of the foregoing, the authors of the present invention proposed to develop a process for modifying a polymeric part in order to impart antistatic properties thereto or to improve these properties, which does not have limitations of the processes mentioned below.

### DISCLOSURE OF THE INVENTION

Thus, the invention relates to a process for chemically modifying a polymeric part in order to impart antistatic properties thereto or to improve these properties, comprising the following steps:
a step of reacting a polymeric part comprising at least one polymer comprising, as reactive groups, amine groups and/or hydroxyl groups, with a functional compound, also called first compound, comprising at least one isocyanate group and at least one heterocyclic type polymerisable group, the isocyanate groups covalently reacting with all or part of the amine groups and/or hydroxyl groups of the polymer(s), whereby this results in a polymeric part which is covalently bonded to residues of the functional compound;
from the heterocyclic type polymerisable groups of the residues of the functional compound, a step of polymerising a second compound comprising at least one heterocyclic type polymerisable group in the presence of a metal complex, said reaction step and said polymerisation step being carried out in the presence of at least one supercritical fluid.

By polymeric part, it is set out that it is a part made of a material comprising at least one polymer comprising, as reactive groups, amine groups and/or hydroxyl groups, said polymer or polymers being shaped into the part, for example, by a shaping technique such as the 3D printing technique or the extrusion/injection technique, the process of the invention thus being able to form part of the manufacturing cycle of a part at the “post-process” stage (that is, the stage of finishing the part after its shaping).

By using of at least one supercritical fluid to implement the above-mentioned steps, the following advantages have been noticed:
the possibility of driving the functional compound and the second compound in the depth of the polymeric part and thus allowing a chemical modification of the latter both on the surface and in depth and thus in the whole part;
a high solvating power, which makes it possible to impart a much faster reaction kinetics to the steps in comparison with similar reactions which would be carried out in a non-supercritical medium;
the possibility of carrying out said modification without using volatile organic solvent, the removal of which after the reaction would be energy- and time-consuming and traces of which would be likely to be present in the treated parts;
the possibility of carrying out said modification while limiting the amount of reagent(s) used, if necessary, of catalyst(s), as well as the residual amount of reagent(s), if necessary, of catalyst(s) in the polymeric parts in comparison with conventional impregnation processes.

Besides, the process of the invention may have the following advantages:
an easily industrialisable process comprising a small number of steps, generally not requiring large amounts of products (which is an advantage of the use of a supercritical fluid in comparison with immersion techniques in a liquid solvent) and allowing simultaneous treatment of several parts;
no prior preparation of the surface of the parts to be treated;
the possibility of treating all the complex reliefs of the parts, if necessary.

By supercritical fluid it is meant a fluid brought to a pressure and a temperature above its critical point, corresponding to the temperature and pressure pair (Tc and Pc respectively), for which the liquid phase and the gaseous phase have the same density and above which the fluid is in its supercritical range. Under supercritical conditions, the fluid has a much higher dissolving power than the same fluid under non-supercritical conditions and thus facilitates the solubilisation of the functional compound and the second compound. It is understood that the supercritical fluid used is capable of solubilising the functional compound and the second compound used.

The supercritical fluid can advantageously be supercritical CO₂, in particular because of its low critical temperature (31° C.), which makes it possible to carry out the reaction at low temperature without risk of degradation of the functional compound and the second compound. More precisely, supercritical CO₂ is obtained by heating carbon dioxide above its critical temperature (31° C.) and compressing it above its critical pressure (73 bar). Moreover, supercritical CO₂ is non-flammable, non-toxic, relatively cheap and does not require reprocessing at the end of the process, compared to processes involving the exclusive use of organic solvents, which also makes it a “green” solvent of industrial relevance. Finally, supercritical CO₂ has good solvating power (adaptable depending on the pressure and temperature conditions used), low viscosity and high diffusivity. Finally, its gaseous nature under ambient pressure and temperature conditions makes the steps of separating the modified part from the reaction medium (including, for example, unreacted compounds) and reusing the CO₂ easy to carry out, at the end of the steps and once the CO₂ has returned to a non-supercritical state. Besides, supercritical CO₂ is able to diffuse in the depth of the polymeric part and contribute to its plasticisation, which can facilitate the reaction steps. All of the above conditions contribute to make supercritical CO₂ an excellent choice of solvent to carry out the steps of the process according to the invention.

As mentioned above, the process according to the invention comprises, firstly, a step of reacting a polymeric part comprising at least one polymer comprising, as reactive groups, amine groups and/or hydroxyl groups, with a functional compound, also called first compound, comprising at least one isocyanate group and at least one heterocyclic type polymerisable group, the isocyanate groups covalently reacting with all or part of the amine groups and/or hydroxyl groups of the polymer(s), whereby this results in a polymeric part which is covalently bonded to residues of the functional compound (the residues being what remains of the functional compound after it has reacted via its isocyanate group(s) with the amine groups and/or hydroxyl functions of the polymeric part, it being understood that these residues still comprise at least one heterocyclic type polymerisable group).

The polymeric part to be treated in accordance with the process of the invention is a part comprising (or even consisting exclusively of) at least one polymer comprising, as reactive groups, amine groups and/or hydroxyl groups, the amine groups covalently reacting with the isocyanate groups of the functional compound to form a urea linkage and the hydroxyl groups covalently reacting with the isocyanate groups of the functional compound(s) to form a urethane linkage.

In particular, the polymeric part to be treated in accordance may be a part comprising (or even consisting exclusively of) one or more polyamides and, even more specifically, the polymeric part may be a polyamide-12 part, the reactive groups in this case being amine groups.

More specifically, the part may be made of porous or partially porous polyamide-12 and, even more specifically, the part may be made of polyamide-12 having a density less than or equal to 960 kg/m³, for example ranging from 650 kg/m³ to 960 kg/m³, preferably less than or equal to 900 kg/m³, for example ranging from 700 kg/m³ to 900 kg/m³.

The functional compound is advantageously a non-polymeric compound, that is, it is not a polymer, that is, a compound comprising a sequence of repeating unit(s), which allows it to access the core of the polymeric part more easily and react covalently with the reactive groups located in the core of the polymeric part.

Depending on the functional compound selected, the person skilled in the art will choose operating parameters to allow the covalent reaction with the reactive groups of the polymeric part, wherein these operating parameters can be determined by preliminary tests.

As an example, when the polymer is a polyamide-12, the reaction step can be illustrated by the following simplified reaction scheme:

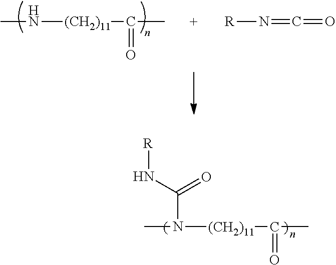

R—NH—CO corresponding to a residue of the functional compound R—N═C=O covalently bonded to the polyamide via the nitrogen atom and n corresponding to the number of repetitions of the repeating unit taken between brackets.

More specifically, the functional compound may be a compound comprising an isocyanate group and at least one heterocyclic type polymerisable group, such as a thiophene group.

More specifically, the functional compound may be a compound comprising an isocyanate group and a (3,4-ethylenedioxy)thiophene group, the latter being a polymerisable group via the thiophene function.

In particular, the compound may have the following formula:

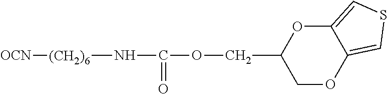

this compound can be prepared beforehand by a nucleophilic addition reaction of hydroxymethyl(3,4-ethylenedioxy)thiophene with hexamethylenediisocyanate, said nucleophilic addition reaction being illustrated by the following reaction scheme:

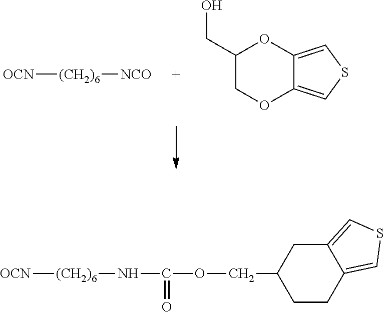

This nucleophilic addition reaction may be implemented in a medium not comprising supercritical fluid(s).

Furthermore, the reaction step of the process of the invention may be carried out in the presence of at least one cosolvent, which may make it possible to improve solubility of the functional compound and/or to improve the plasticity of the polymeric part and thus facilitate accession of the functional compound to the core of the polymeric part.

Furthermore, the reaction step may be carried out in the presence of at least one catalyst.

More specifically, the reaction step may comprise the following operations:
an operation of placing, in a reactor, the polymeric part, the functional compound, optionally at least one cosolvent and optionally at least one catalyst;
an operation of introducing CO₂ into the reactor;
an operation of pressurising and heating the reactor to a temperature higher than the critical temperature of CO₂ and to a pressure higher than the critical pressure of CO₂, this temperature and this pressure being maintained until the reaction is complete.

Alternatively, the reactor pressurisation and heating operation may be sequenced as follows:
an operation of pressurising and heating the reactor to a temperature higher than the critical temperature of CO₂ and to a pressure higher than the critical pressure of CO₂, the temperature and the pressure being chosen to generate an impregnation without reaction of the polymeric part with the functional compound followed by an optional precipitation of the functional compound;
an operation of increasing the pressure and the temperature, the temperature and the pressure being set so as to allow covalent reaction of the functional compound with the part, this temperature and this pressure being maintained until said reaction is complete,

this sequence of operations may be repeated once or more.

Advantageously, the placement operation can be carried out in such a way that there is no direct contact between the polymeric part and the functional compound, the optional catalyst and the optional cosolvent.

At the end of the reaction step, the polymeric parts are thus chemically modified and are covalently bonded to (or covalently grafted with) residues of the functional compound (that is, what remains of the functional compound after covalent reaction of the isocyanate groups with the reactive groups of the polymer, it being understood that these residues still comprise at least one heterocyclic type polymerisable group).

After the reaction step, the supercritical conditions are conventionally removed, for example, by depressurising the reactor in which the reaction took place.

The polymeric part thus modified can then be subjected to drying, for example, under vacuum.

Secondly, the process of the invention comprises, from the heterocyclic type polymerisable groups of the residues of the functional compound, a step of polymerising a second compound comprising at least one heterocyclic type polymerisable group in the presence of a metal complex, the polymerisation thus propagating from the residues of the functional compound, via the heterocyclic type polymerisable groups thereof. At the end of this step, there thus remains a polymeric part bonded to grafts consisting of polymeric chains resulting from the polymerisation of the second compound, the linkage between the polymeric part and the grafts being made via the residues of the functional compound which form organic spacer groups between the polymeric part and the grafts, these residues being bonded, on the one hand, covalently to the polymeric part and, on the other hand, covalently to the above-mentioned grafts. In this case, the residues are what remains of the functional compound after it has reacted, on the one hand, via its isocyanate group(s) with the amine groups and/or hydroxyl groups of the polymer(s) of the polymeric part and, on the other hand, via its heterocyclic type polymerisable group(s) with the second compound.

This polymerisation reaction step is carried out in the presence of at least one supercritical fluid, advantageously identical to that used during the reaction step with the functional compound, such as supercritical CO₂.

The second compound comprises at least one heterocyclic type polymerisable group, such as a thiophene group, which group(s) may be identical to or different from the polymerisable group(s) of the functional compound.

In particular, the second compound may be a (3,4-ethylenedioxy) thiophene compound (also designated by the abbreviation EDOT).

As for the metal complex, it may be an iron (III) complex, such as iron (III) p-toluenesulfonate or iron (III) trifluoromethanesulfonate, this metal complex contributing to initiate the redox polymerisation and also to dope the resulting polymer to activate antistatic properties thereof.

The polymerisation step may be a redox polymerisation reaction, this reaction being induced by the metal complex.

More specifically, the polymerisation reaction step may include the following operations:
an operation of placing, in a reactor, the polymeric part having reacted with the functional compound and the second polymerisable compound;
an operation of introducing liquid CO₂ into the reactor;
an operation of pressurising and heating the reactor to a temperature higher than the critical temperature of CO₂ and to a pressure higher than the critical pressure of CO₂, in order to generate an impregnation without reaction of the polymeric part with the second compound(s), followed by an optional precipitation of the second compound(s);
an operation of introducing the metal complex into the reactor, the temperature and pressure being maintained at supercritical values.

Advantageously, the placement operation can be carried out in such a way that there is no direct contact between the polymeric part and the compound(s), the optional catalyst, the optional cosolvent and the optional other ingredient(s).

At the end of the polymerisation reaction step, the process advantageously comprises a step of stopping the supercritical conditions and possibly a step of drying the modified polymeric part.

The process of the invention can be implemented in a device, for example, of the autoclave type, comprising an enclosure for receiving the polymeric part, the reagents, the supercritical fluid, the optional cosolvent and optional catalyst, means for regulating the pressure of said enclosure in order to vacuum draw the latter (for example, via a vacuum pump communicating with the enclosure) and heating means.

Further advantages and features of the invention will become apparent from the non-limiting detailed description below.

### DETAILED DESCRIPTION OF PREFERRED EMBODIMENTS

### Example 1

This example illustrates the implementation of a specific embodiment of the chemical modification process of the invention consisting of a chemical modification of a polyamide-12 part, so as to improve its electrical conductivity.

To do so, the conductive polymer PEDOT (or Poly(3,4-ethylenedioxythiophene)) was chosen. However, PEDOT is insoluble in supercritical CO2 and can only be implemented by direct polymerisation on the substrate through a redox reaction of the monomer (EDOT) with an iron complex. As EDOT (and PEDOT) cannot be directly bonded/grafted to the PA-12 matrix, specific grafting was thereby contemplated.

Therefore, three phases, which will be developed below in more detail, were implemented:

a) a phase of synthesising, in liquid phase, an intermediate compound (hereafter called isocyanate/EDOT intermediate compound) by reaction of hexamethyldiisocyanate with an EDOT-OH compound, this step can be illustrated by the following reaction scheme:

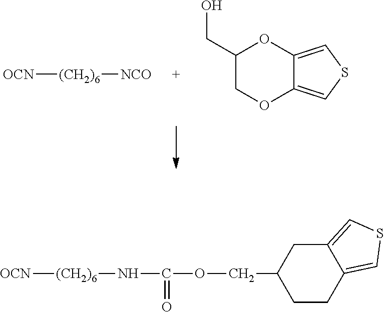

b) a phase of grafting, under supercritical CO₂, the intermediate compound with polyamide-12, this step can be illustrated by the following reaction scheme:

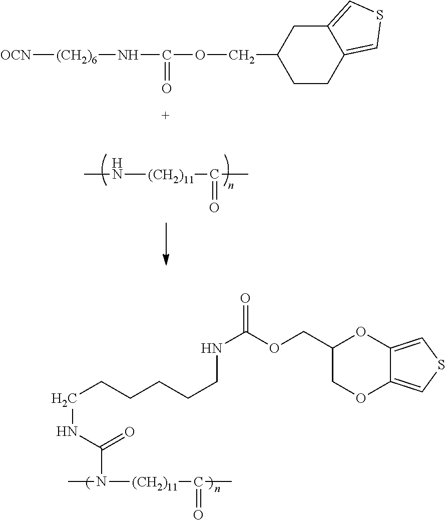

n corresponding to the number of repetitions of the unit taken between brackets;

c) a phase of polymerising, under supercritical CO₂, the 3,4-ethylenedioxythiophene (EDOT) monomer into PEDOT and doping with an iron Fe (III) based complex to obtain a conductive polymer, this step can be illustrated by the following reaction scheme:

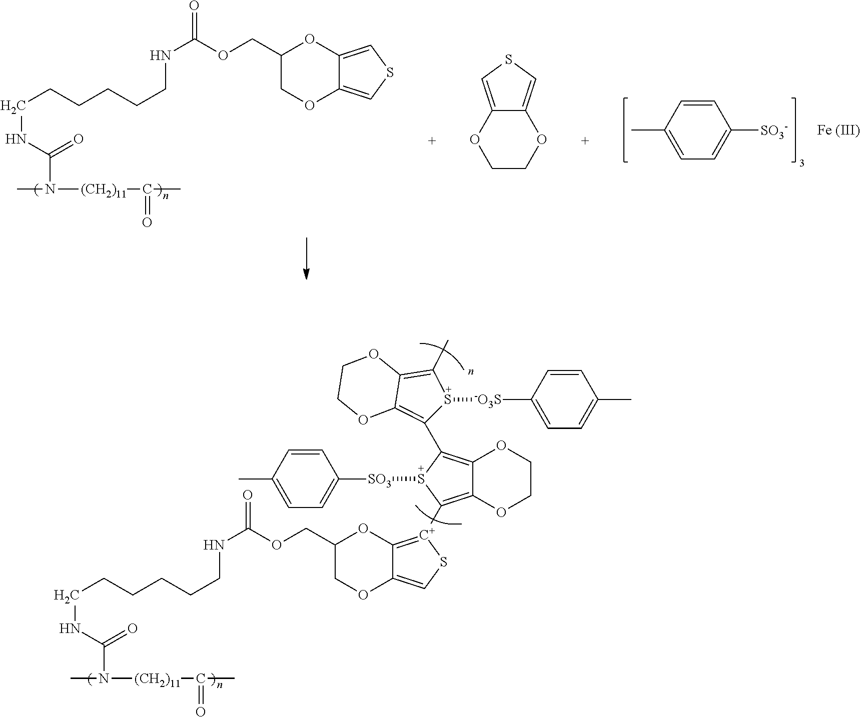

n corresponding to the number of repetitions of the units taken between brackets.)

1° Synthesis of the Isocyanate/EDOT Intermediate Compound

The table below illustrates, in order, the steps leading to the synthesis of the isocyanate/EDOT intermediate compound.

| | |
|---|---|
| Step 1 | Introducing 260 mg of 1,4-diazabicyclo[2.2.2]octane (DABCO) |
| | (2.32 mmol), as catalyst, into a glass container |
| Step 2 | Flushing the container with argon |
| Step 3 | Adding 15 mL of diethyl ether |
| Step 4 | Stirring the mixture under argon bubbling until the DABCO |
| | is completely dissolved |
| Step 5 | Adding 500 mg of EDOT-OH (2.90 mmol) previously dissolved |
| | in 4 mL of diethyl ether |
| Step 6 | Adding 10 mL of anhydrous acetone |
| Step 7 | Adding 487 mg of hexamethyldiisocyanate (2.90 mmol) |
| Step 8 | Stirring the mixture under argon bubbling until the reagents |
| | are completely dissolved |
| Step 9 | Obtaining the isocyanate/EDOT intermediate compound |

2° Grafting the Intermediate Compound onto a Polyamide-12 Part and Polymerising into PEDOT and Doping

The initial polyamide-12 part is a disc of 60 mm diameter, 5 mm thick and having a mass of 7.8 g and a surface resistivity of 10¹¹ ohm/square.

The above-mentioned part is subjected to the following successive steps:
a step of impregnating/grafting the intermediate compound (called below “Step 1”);
a step of impregnation with the EDOT monomer (called below “Step 2”);
a step of impregnation with the iron (III) complex allowing both the polymerisation of the EDOT monomer and doping of the polymer thus formed to make it conductive (called below “Step 3”).

These three steps are carried out under supercritical CO₂ in a batch reactor. More specifically, the reactor is a 600 mL stainless steel batch reactor equipped with an external heating system. CO₂ is introduced into the reactor with a double piston pump the heads of which are cooled to a temperature below 5° C. in order to have CO₂ in liquid phase at this stage before the reaction. It is provided with a 60 mL crystalliser at the bottom for accommodating the reagents, optional catalyst and optional cosolvent. The polyamide-12 part is suspended above the crystalliser to avoid any contact with it. The experiments start at room pressure. The reactor is then pressurised to a target pressure and heated to the desired temperature. The part is maintained under the treatment conditions for the required time until the reaction in question is complete. Heating of the reactor is then stopped inducing a slow depressurisation. The remaining pressure is discharged with the various valves located on the reactor lid.

More specifically, the operating conditions for the above steps are listed in the table below.

| | |
|---|---|
| Step 1 | Introducing the previously synthesised isocyanate/EDOT |
| | intermediate compound and reacting under supercritical CO₂ |
| | (300 bar, 100° C.) for 4 hours |
| Step 2 | Introducing 2 g of EDOT into the reactor under supercritical |
| | CO₂ (300 bar, 100° C.) for 4 hours |
| Step 3 | Introducing 2 g of iron (III) p-toluenesulphonate into the |
| | reactor under supercritical CO₂ (300 bar, 100° C.) for 2 |
| | hours |

The part obtained at the end of these steps has a mass gain of 2%, a good coating homogeneity and a surface resistivity of 108 ohm/square (that is an improvement by a factor of 1000).

What is claimed is:

1.-14. (canceled)

15. A process for chemically modifying a polymeric part in order to impart antistatic properties thereto or to improve these properties, comprising the following steps:
a step of reacting a polymeric part comprising at least one polymer comprising, as reactive groups, amine groups and/or hydroxyl groups, with a functional compound, also called first compound, comprising at least one isocyanate group and at least one heterocyclic type polymerisable group, the isocyanate groups covalently reacting with all or part of the amine groups and/or hydroxyl groups of the polymer(s), whereby this results in a polymeric part which is covalently bonded to residues of the functional compound;
from the heterocyclic type polymerisable groups of the residues of the functional compound, a step of polymerising a second compound comprising at least one heterocyclic type polymerisable group in the presence of a metal complex,
said reaction step and said polymerisation step being carried out in the presence of at least one supercritical fluid.

16. The process of claim 15, wherein the supercritical fluid is supercritical CO₂.

17. The process of claim 15, wherein the polymeric part is a part comprising one or more polyamides.

18. The process according to claim 15, wherein the polymeric part is a polyamide-12 part.

19. The process according to claim 15, wherein the polymeric part is a polyamide-12 part, which has a density less than or equal to 960 kg/m³.

20. The process according to claim 19, wherein the density is less than or equal to 900 kg/m³.

21. The process according to claim 15, wherein the functional compound is a non-polymeric compound.

22. The process according to claim 15, wherein the functional compound comprises, as a heterocyclic type polymerisable group, a thiophene group.

23. The process according to claim 15, wherein the functional compound comprises an isocyanate group and a (3,4-ethylenedioxy)thiophene group.

24. The process according to claim 15, wherein the functional compound has the following formula:

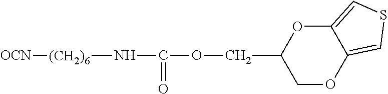

25. The process according to claim 15, wherein the reaction step comprises the following operations:
an operation of placing, in a reactor, the polymeric part, the functional compound, optionally at least one cosolvent and optionally at least one catalyst;
an operation of introducing CO₂ into the reactor;
an operation of pressurising and heating the reactor to a temperature higher than the critical temperature of the CO₂ and to a pressure higher than the critical pressure of the CO₂, this temperature and this pressure being maintained until the reaction is complete.

26. The process according to claim 15, wherein the polymerisation reaction step is carried out in the presence of at least one supercritical fluid, identical to that used in the reaction step with the functional compound.

27. The process according to claim 15, wherein the second compound comprises, as heterocyclic type polymerisation group(s), a thiophene group.

28. The process according to claim 15, wherein the second compound is a (3,4-ethylenedioxy) thiophene compound.

29. The process according to claim 15, wherein the metal complex is an iron (III) complex.
